(19) United States
(12) Patent Application Publication
(10) Pub. No.: US 2021/0196426 A1
(43) Pub. Date: Jul. 1, 2021

(54) MIXING CAPSULE, IN PARTICULAR FOR THE FIELD OF DENTISTRY

(71) Applicant: KULZER GMBH, Hanau (DE)

(72) Inventor: Andrea KEMENY, Friedrichsdorf (DE)

(73) Assignee: KULZER GMBH, Hanau (DE)

(21) Appl. No.: 17/268,819

(22) PCT Filed: Sep. 11, 2019
(86) PCT No.: PCT/EP2019/074163

§ 371 Date: Feb. 16, 2021

(30) Foreign Application Priority Data
Sep. 12, 2018 (DE) 10 2018 122 288.2

(51) Int. Cl. A61C 5/68; A61C 5/66; A61C 5/64

(52) U.S. Cl. CPC A61C 5/68; A61C 5/64; A61C 5/66

(57) ABSTRACT

The invention relates to a mixing capsule (1) comprising a housing (2), characterised in that a first part of the housing (3) is mounted rotatably about a rotational axis against a second part of the housing (4), the rotational axis corresponding to the longitudinal axis of the housing (2), the first part of the housing (3) comprising at least one first chamber (5) to receive a composition A, the second part of the housing (4) comprising at least one second chamber (6) to receive a composition B, the at least one first chamber (5) and the at least one second chamber (6) being initially closed respectively, a first outlet opening (7) of the at least one first chamber (5) standing substantially congruently above a second outlet opening (8) of the at least one second chamber (6) when the first part of the housing (3) being rotated about a predefined angle against the second part of the housing (4), the first outlet opening (7) and/or the second outlet opening (8) being adapted to transfer composition A into the at least one second chamber (6) and/or composition B into the at least one first chamber (5). The invention further relates to a method for mixing at least two compositions A and B to a composition C in a mixing capsule. Likewise, the invention relates to a use of a mixing capsule for storing, mixing and applicating pasty to kneadable dental two-component compositions.

The present invention relates to a mixing capsule, in particular for dental field.

A multitude of mixing capsules in dental field being suitable for storing and mixing of two-component compositions are known from the state of the art. Mixing capsules in dental field are normally characterised by their short length of approximately 32 mm to allow insertion of the mixing capsule into the fixing brackets of known mixers. The mixing capsules according to the state of the art normally have two chambers separated by a foil having a predetermined breaking point which comprise one of the two components of the two-component composition respectively, wherein a piston penetrates the foil prior to mixing.

Disadvantageously, the known mixing capsules are normally adapted to mix a liquid monomer component with a powdered component. Almost no economically producible or easy-to-use mixing capsules are known from the state of the art having the ability to mix also two pasty to kneadable 2K-component compositions with each other. Preferred compositions A and B are pasty and thixotropic compositions.

It was the object of the invention to develop a mixing capsule allowing storage and mixing of pasty to kneadable and optionally with powdered or pasty to solid and concurrently thixotropic multi-component compositions, wherein liquid with powdered components are preferably being mixed also. Furthermore, it was the object to dimension the mixing capsule such to be insertable into common mixing apparatuses, such as being present in dental practices.

The object of the present invention is solved by a mixing capsule comprising a housing, a first part of the housing being mounted rotatably against a second part of the housing about a rotational axis, the rotational axis corresponding to the longitudinal axis of the housing, the first part of the housing comprising at least one first chamber to receive a composition A, the second part of the housing comprising at least one second chamber to receive a composition B, the at least one first chamber and the at least one second chamber being initially closed respectively, a first outlet opening of the at least one first chamber standing substantially congruently above a second outlet opening of the at least one second chamber when the first part of the housing being rotated about a predefined angle against the second part of the housing, the first outlet opening and/or the second outlet opening being adapted to make composition A transferable into the at least one second chamber and/or composition B into the at least one first chamber, in particular to allow transfer of the respective composition into the other chamber respectively.

In doing so, the mixing capsule according to the invention has the advantage over the state of the art that spatially separated storing and transporting of at least two components and mixtures thereof to a composition C may happen in one and the same container. Furthermore, there is a certain independence from consistency of the at least two components: Fluids as well as pasty to kneadable compositions may be mixed with each other by means of the mixing capsule according to the invention.

In an embodiment, the housing of the mixing capsule largely corresponds to a cylinder. In an embodiment, the first part of the housing corresponds to a first partial cylinder of the cylinder of the complete housing of the mixing capsule. In an embodiment, the second part of the housing corresponds to a second partial cylinder of the cylinder of the complete housing of the mixing capsule. The first and the second part of the cylindrical housing are mounted rotatably about the longitudinal axis of the cylinder.

Alternatively, the housing has the form of a sphere, of an ellipsoid, of a body having a polygonal cross-section, of a rotationally symmetric freeform or of a prism. In case of a sphere, the first part of the housing for example is a first hemisphere and the second part of the housing is a second hemisphere or the first part of the housing is a first partial sphere and the second part of the housing is a second partial sphere. In case of an ellipsoid, the first part of the housing is a first part of the ellipsoid and the second part of the housing is a second part of the ellipsoid. In case of a body having a polygonal cross-section, the first part of the housing is a first part of the body having the polygonal cross-section and the second part of the housing is a second part of the housing having the polygonal cross-section. In case of a rotationally symmetric freeform, the first part of the housing is a first part of the rotationally symmetric freeform and the second part of the housing is a second part of the rotationally symmetric freeform. In case of a prism, the first part of the housing is a first part of the prism and the second part of the housing is a second part of the prism. Conceivable are also hybrid forms to form the housing. Like this, in a further embodiment, the first part of the housing may be a prism and the second part of the housing may be a hemisphere for example.

The at least one first chamber of the first part of the housing and the at least one second chamber of the second part of the housing are initially closed in the delivery state, for example by a foil at the first outlet opening or at the second outlet opening respectively. The foil is easy to break through during the mixing process. Alternatively, a predetermined breaking point may be present at the first and/or second outlet opening. Both the first and also the second chamber are preferably present as a blind hole and thus only have an opening on one side in the form of the respective outlet opening. The first and the second outlet opening are preferably formed in an identical manner.

The predefined angle about which the first part of the housing is rotatable against the second part of the housing results from the relative arrangement of first outlet opening in the first part of the housing and second outlet opening in the second part of the housing.

Congruency in geometry means the congruency of point sets. According to this, congruent position of first outlet opening and second outlet opening means the first outlet opening and the second outlet opening are situated substantially congruently above each other. A partial overlapping of first outlet opening and second outlet opening is sufficient as well, but suboptimal.

The mixing capsule according to the invention with capsule housing preferably has a length of less than or equal to 10 cm, preferably less than or equal to 8 cm, particularly preferably a length of less than or equal to 5 cm or less than or equal to 3.5 cm. The common mixing chamber of the mixing capsule preferably has a length of 2.0 to 4.0 cm, in particular of 2.5 to 3.0 cm with a diameter of 0.5 to 2.0 cm, in particular of 0.8 to 1.2 cm. The volume of the common mixing chamber amounts approximately from 20 to 200 mm³, in particular from 50 mm³ to 135 mm³.

In a further embodiment, it is provided that the at least one first chamber and the at least one second chamber form a common mixing chamber when the first outlet opening with the second outlet opening being in substantially congruent position, composition A and composition B being stored in the common mixing chamber mixably to composition C and being mixed to composition C by moving the mixing capsule.

The central axes of the at least one first chamber and of the at least one second chamber are coaxially in line when the first and second outlet opening being in congruent position, so that the at least one first chamber and the at least one second chamber form a common lumen, thus a common mixing chamber. Like this, the storage space provided is efficiently used for mixing compositions A and B. No additional volume is required for the mixing process.

In case of for example a third chamber with a composition D and a fourth chamber with a composition E being present in an embodiment, formation of a further common mixing chamber may occur when the third and fourth outlet opening being in congruent position, in which for example composition D and composition E are mixed to composition F. Depending on the size of the mixing capsule, the first part of the housing may have a multitude of first chambers and the second part of the housing may have a multitude of second chambers forming a multitude of common mixing chamber when being in congruent position to each other.

In a further embodiment, it is provided that the first part of the housing comprises at least one first magnet and the second part of the housing comprises at least one second magnet, the at least one first magnet and the at least one second magnet being adapted, when being in congruent position to each other, to keep together the first part of the housing and the second part of the housing to be the housing.

The first part of the housing is separably connected to the second part of the housing in advantageous manner. The relative position of first part and second part of the housing to each other may be changed quickly and without great effort. Likewise, the first and/or the second part of the housing may be replaced by other compatible first and/or second parts of other mixing capsules of the same type. Thus, the mixing system remains flexible anytime.

Other mechanisms effecting cohesion of first and second part of the housing are also conceivable instead of using magnets, thus e.g. a snap fit or a rail system with engaging mechanism.

In an embodiment, the at least one first magnet and the at least one second magnet may be permanent magnets. Permanent magnets have a static magnetic field. Such permanent magnets have an amount of iron, nickel, cobalt and/or are alloys comprising at least one of the afore-mentioned metals.

The number of magnets per first part of the housing and per second part of the housing is variable and largely depends of the form of the housing of the mixing capsule.

In a further embodiment, the at least one first magnet and the at least one second magnet comprise neodymium.

Neodymium magnets have the strength required to keep together the first and second part of the housing in an advantageous manner. Neodymium magnets are even strong enough to keep together the first and second part of the housing even in case of vibration when being transported or mixed during the mixing phase.

Neodymium is a chemical element having the chemical symbol Nd and the atomic number 60. It is placed in the periodic system in the lanthanoids' series and thus ranks among the rare-earth metals. The metal is used for strong permanent magnets in the form of neodymium iron boron alloy.

In a further embodiment, the at least one first magnet and the at least one second magnet comprise samarium cobalt.

Samarium cobalt (abbreviated SmCo) is an alloy of the rare-earth metal samarium (Sm) with the metal cobalt (Co). Two crystal structures are suitable for use as permanent magnet: SmCo₅, without additional alloy elements, and Sm₂Co₁₇ with iron, copper and zirconium as additional alloy elements.

In a further embodiment, it is provided that the at least one first chamber and/or the at least one second chamber are adapted to receive composition C after separation of the first part of the housing from the second part of the housing.

The at least one first chamber and/or the at least one second chamber are generously dimensioned in a spacial manner such that each chamber may receive composition C, thus the product made of composition A and composition B, by itself. The mixing product, composition C, may be provided in one of the two parts when the first part being separated from the second part of the housing. This enhances user friendliness of the mixing system.

In an embodiment, the first mixing chamber and/or the second mixing chamber have the form of a hollow cylinder. In a further embodiment, the first mixing chamber and/or the second mixing chamber have the form of a hemisphere. The lumen of first mixing chamber and/or second mixing chamber is designable at will, as long as being suitable to store composition A or B respectively and to provide the mixing product, composition C, in a user-friendly manner.

In a further embodiment, the at least one first chamber and/or the at least one second chamber comprise a limited lumen.

In this way, the neodymium magnets may be kept free from compositions A, B and C in a mixing capsule in an advantageous manner. Smears within the mixing capsule do not occur. A third and fourth chamber is also conceivable in which a composition D or E respectively are stored. In case of a multitude of first chambers of the first part of the housing and a multitude of second chambers of the second part of the housing, a multitude of common mixing chambers may be created, so that a multi-component mixing capsule appears practicable.

In a further embodiment, it is provided for the predefined angle of the rotation of the first part of the housing against the second part of the housing, in order to make a first outlet opening of the at least one first chamber standing congruently above a second outlet opening of the at least one second chamber, to be an angle between 0 to 360 degrees, in particular 90 degrees, 180 degrees or 270 degrees.

In this way, different relative positions of the first and the second part of the housing to each other may be realised in advantageous manner by them being rotated against each other about the longitudinal axis of the housing. Cohesion of the first and the second part of the housing is strongest respectively if first magnets of the first part of the housing stand congruently to second magnets of the second part of the housing.

The predefined angle of the rotation of the first part of the housing against the second part of the housing depends on the arrangement and number of the first magnets on the first part of the housing and on the arrangement and number of the second magnets on the second part of the housing.

In an embodiment (FIG. 3a and FIG. 3b), three magnets are arranged on the first part of the housing, the three first magnets and the first chamber being spaced apart by an angle of 90 degrees respectively. Merely one second magnet and a second chamber are situated on the second part of the housing, the second magnet and the second chamber being spaced apart to each other by an angle of 180 degrees. The second part of the housing may be rotated against the first part of the housing by about 90 degrees, 180 degrees or about 270 degrees to achieve congruency between the first magnets and the second magnet. However, merely a relative position between first part of the housing and second part of the housing is relevant for achieving congruency between the first outlet opening of the first chamber and the second outlet opening of the second chamber in mixing phase. Three relative positions are available for storage and transport phase in which one of the first magnets of the first part of the housing stands congruently to the second magnet of the second part of the housing, but not the first and second outlet opening to each other.

The predefined angle of the rotation of the first part of the housing against the second part of the housing particularly depends on the starting position and the relative position of first and second part of the housing. Thus, an angle between 0 and 360 degrees may arise out of achieving congruency between first and second magnets or congruency between first and second outlet opening respectively.

In a further embodiment, it is provided for the at least one first chamber and the at least one second chamber to communicate which each other when the first outlet opening and the second outlet opening being in congruent position.

The first and the second outlet opening are initially closed by a foil. The respective foil may be easily broken through by merely mixing when the first and the second outlet opening standing congruently above each other, so that the at least one first chamber and the at least one second chamber communicate which each other. In this way, composition A of the first chamber of the first part of the housing may be transferred into the second chamber of the second part of the housing. At the same time, composition B of the second chamber of the second part of the housing may be transferred into the first chamber of the first part of the housing. Thus, a common mixing chamber is formed in which composition A and composition B are being mixed to composition C. The first and/or second mixing chamber are to be understood as being parts of the producible common mixing chamber and may form the complete mixing chamber in which the mixture is carried out.

In a further embodiment, the first part of the housing has a first protrusion at its side averting the second part of the housing and the second part of the housing has a second protrusion at its side averting the first part of the housing. The respective protrusion may be formed as cam or lug. Preferably, in said embodiment, the first part of the housing has a first cylinder at its side averting the second part of the housing and the second part of the housing has a second cylinder at its side averting the first part of the housing.

Each of the single parts is able to stand when separating first part and second part of the housing, thus providing the mixing product, composition C, for the user in an advantageous manner. Furthermore, the cylinders serve for clamping the mixing capsule into a mixing apparatus. The distance between first and second cylinder is dimensioned such that the mixing capsule may be compatibly clamped into known commercial mixing apparatuses synonymous to universal mixer. The first and second cylinder is also suitable for manual mixing by hand because in doing so the mixing capsule may be positioned in an advantageous manner between thumb and finger.

Other body shapes are also conceivable instead of cylinder shape, thus for example the form of a hemisphere, of a hemi-ellipsoid, of a cube, of a cuboid and/or of a prism.

In a further embodiment, the first part of the housing and/or the second part of the housing is made of an opaque material.

In this way, the mixing process in the common mixing chamber may be observed in an advantageous manner. In addition, it is possible to see to what extend the first part of the housing must be rotated against the second part of the housing to make first and second outlet opening being situated congruently above each other. Furthermore, it is possible to see the magnets and to know to what extend the first part of the housing must be rotated against the second part of the housing to make first and second magnets standing congruently to each other.

Opaque materials are for example acrylic glass (chemically polymethyl methacrylate, abbreviation PMMA) or other transparent plastics, such as thermoplastic polyesters, polycarbonate or polystyrene plastics.

Alternatively, the first and/or second part of the housing is not opaque. The material from which the single parts of the mixing capsule, such as the capsule housing and the cylinder, are then made of preferably comprises a tribologically modified plastic, such as PBT-POM, polybutylene terephthalate (PBT), polyoxymethylene (POM), as well as plastics comprising organic and/or inorganic fillers, such as e.g. the following additives, such as silicone oil, graphite (GR), fluorocarbon (TF), carbon fibres (CF), MoS2 (MO), polyolefin waxes or other solid lubricants. Likewise suitable materials for producing the afore-mentioned capsule components may be selected from a polymeric material, filled polymeric material, a fiber-reinforced polymer, hybrid material, wherein the polymeric material may be selected from polyamide, fluoropolymers, polysulfide-containing polymers, polysulfone-containing polymers, polyaryl ether ketones, polyimides, PAEK (polyaryl ether ketones), PEEK (polyether ether ketones), PEK (polyether ketones), PEKK (polyether ketone ketones), PEEEK (polyether ether ether ketones), PEEKK (polyether ether ketone ketones), PEKEKK (polyether ketone ether ketone ketones), PES (polyether sulfones), PPSU (polyphenylene sulfones), PSU (polysulfones), PPS (polyphenylene sulfides), PFA (perfluoroalkoxy polymers), PFE (poly(fluorenylene ethynylene) polymers), PVDF (polyvinylidene fluorides), PCTFE (polytetrafluoroethylene), PAI (polyamide imides), PI (polyimides), PEI (polyether imides), PBI (polybenzimidazoles).

In a further embodiment, the housing of the mixing capsule comprises cyclic olefin polymer, cyclic olefin copolymers, polyethylene, polypropylene, polyethylene having low density (LDPE), polyethylene having high density (HDPE), polypropylene having low density (LDPP), polypropylene having high density (HDPP) and/or mixtures containing at least one of said polymers.

Cyclic olefin copolymers have high stiffness, strength and hardness as well as low density and high transparency with good acid and lye resistance. The extremely low water absorption/water vapour permeability are to be pointed out. All polyethylene types are characterized by high chemical resistance, good electrical insulation capacity and good gliding behaviour.

PE-HD (HDPE): lightly branched polymer chains, thus high density between 0.94 g/cm³ and 0.97 g/cm³, (‘HD’ signifies ‘high density’). PE-LD (LDPE): strongly branched polymer chains, thus low density between 0.915 g/cm³ and 0.935 g/cm³, (‘LD’ signifies ‘low density’). High crystallinity of polymers leads to high density, stiffness, hardness, abrasion resistance, use temperature and chemical resistance. Polyethylene has high resistance to acids, lyes and further chemicals. Polyethylene hardly absorbs water. Gas and water vapour permeability (only polar gases) is lower than for most plastics; whereas it makes oxygen, carbon dioxide and flavourings passing through well. The properties of polypropylene are similar to polyethylene; it is yet harder and more heat resistant.

In further embodiment, the mixing capsule has an initial opening protection, the initial opening protecting being adapted to fix the first part of the housing against the second part of the housing in a rotation-free manner. Moreover, it is preferred for the initial opening protection to close the mixing capsule in a moisture sealing and/or airtight manner.

In this way, the first and the second part of the mixing capsule are kept together when being transported and stored in an advantageous manner. The initial opening protection may be easily removed after delivery and prior to the use phase.

In an embodiment, the initial opening protection is an adhesive tape which encompasses the first and the second part of the housing on the lateral surface in a belt-like manner. In a further embodiment, the initial opening protection is a foil which surrounds the first and the second part of the housing in an all-encompassing manner. Sealing is also conceivable.

In a further embodiment, the invention relates to a method for mixing at least two compositions A and B to a composition C in a mixing capsule, the method comprising the steps of:

Optionally, providing a mixing capsule in which the first part of the housing is arranged against the second part of the housing such that a) the first outlet opening of the at least one first chamber does not stand above the second outlet opening of the at least one second chamber or b) the first chamber comprising composition A and the second chamber comprising composition B are closed respectively, and

optionally, removing the initial opening protection

(i) rotating the first part of the housing against the second part of the housing, until the first outlet opening of the at least one first chamber stands congruently above the second outlet opening of the at least one second chamber;

(ii) mixing composition A and composition B in the common mixing chamber by the mixing capsule being moved;

(iii) separating the first part of the housing from the second part of the housing;

(iv) obtaining composition C in the first chamber and/or in the second chamber.

First of all, opening the initial opening protection of the mixing capsule is required when the mixing capsule being provided in its delivery state. In doing so, the adhesive tape may be easily removed from the mixing capsule. Now, the first and the second part of the housing are only kept together by the first and second magnets and the relative position between first and second part of the housing may be easily changed by rotating the first part of the housing against the second part of the housing.

Thus, a subject matter of the invention is a method for mixing at least two composition A and B to a composition C in the mixing capsule according to the invention, in particular of pasty, kneadable to solid, preferably thixotropic compositions, particularly preferably of dental compositions.

In a further embodiment, (iii) mixing of composition A and composition B in the common mixing chamber is realised by a universal mixer for dental materials. Mixing is normally carried out by periodical shaking movement along the longitudinal axis in a universal mixer.

The mixing process may be realised by means of a known commercial mixer, e.g. 3M-ESPE-CAPMIX, by the mixing capsule being clamped into the mounting provided of the mixer. The mixing capsule is moved at least along a part of the longitudinal axis of the mixing capsule or the capsule housing respectively in an oscillating manner when being mixed. Preferably, the mixing capsule with a part of its longitudinal axis is moved along a circular orbit having a radius in an oscillating manner. Alternatively, manual mixing is feasible.

In a further embodiment, the invention relates to a use of a mixing capsule for storing, mixing and applying pasty to kneadable dental two-component compositions.

Alternatively, the mixing capsule may be used for storing, mixing and applying pasty to kneadable dental multi-component compositions in an embodiment in which the mixing capsule has a multitude of common mixing chambers. The mixing capsule may also be used for storing, mixing and applying fluids, powders and liquids. Thus, a mixing capsule has been developed allowing storage and mixing of pasty to kneadable and optionally with powdered or pasty to solid and concurrently thixotropic multi-component compositions, wherein liquid with powdered components may preferably be mixed also. The mixable compositions are preferably thixotropic dental compositions.

Another subject matter of the invention is a kit comprising a mixing capsule comprising a composition A and a composition B.

Further details, features and advantages of the invention derive from the figures, as well as from the following description of preferred embodiments by reference to the figures. In doing so, the figures merely illustrate exemplary embodiments of the invention not limiting the substantial subject of the invention.

### DESCRIPTION OF THE FIGURES

FIG. 1a shows the mixing capsule 1 according to the invention with an initial opening protection 13.

FIG. 1b shows the mixing capsule 1 according to the invention with a transparent first part of the housing 3.

FIG. 2a shows the same as FIG. 1b.

FIG. 2b shows compositions A and B in the first chamber 5.

FIG. 3a shows the first part of the housing 3 after separation from the second part of the housing 4.

FIG. 3b shows the second part of the housing 4 after separation from the first part of the housing 3.

### EMBODIMENTS OF THE INVENTION

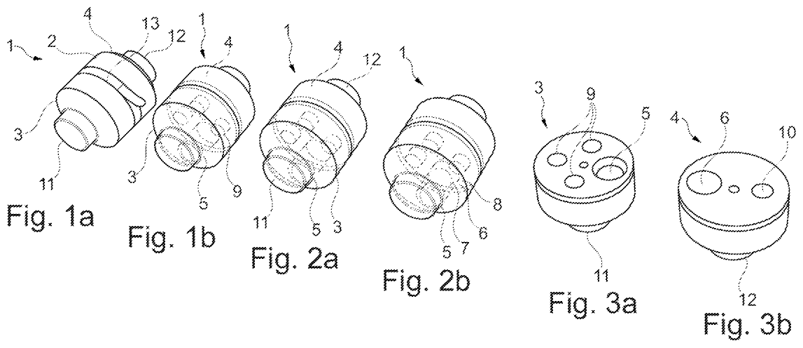

In the embodiment shown in FIGS. 1a to 3b, the housing of the mixing capsule 1 substantially has the form of a cylinder. The mixing capsule in FIGS. 1a to 3b thus has a cylindrical housing. The following description of the mixing capsule refers to this embodiment.

FIG. 1a shows the mixing capsule 1 according to the invention having an initial opening protection 13. The initial opening protection 13 is adapted to fix a first part of the cylindrical housing 3 of the mixing capsule 1 against a second part of the cylindrical housing 4 of the mixing capsule 1 in a rotation-free manner. In the embodiment of FIG. 1a the initial opening protection is an adhesive tape being arranged around the lateral surface of the cylindrical housing 2 in a belt-like manner at the point where the first part of the cylindrical housing 3 and the second part of the cylindrical housing 4 adjoin each other. The cylindrical housing 2 of the mixing capsule 1 has a first cylinder 11 at its base surface and a second cylinder 12 at its top surface, the first part of the cylindrical housing 3 and/or the second part of the cylindrical housing 4 being able to stand by means of the respective cylinders 11, 12. In particular, the first and the second cylinder 11, 12 serve for clamping the mixing capsule in a mounting of a mixing apparatus by which the mixing process is carried out.

FIG. 1b shows a mixing capsule 1 according to the invention having a transparent first part of the cylindrical housing 3. The first part of the cylindrical housing comprises at least one first chamber 5 to receive a composition A. In doing so, the first chamber may have a lumen being similar to a miniaturised test tube. In the embodiment illustrated in FIG. 1b, the chamber 5 has three first neodymium magnets 9 at the interface to the second part of the cylindrical housing 4 which are arranged in parallel to the top and base surface on an imaginary circle, each being shifted at an angle of 90 degrees or 180 degrees respectively. At least one of the three first neodymium magnets 9 of the first part of the cylindrical housing 3 is arranged congruently above at least one second neodymium magnet 10 of the second part of the cylindrical housing 4, so that the first part of the cylindrical housing 3 and the second part of the cylindrical housing 4 are held together and the mixing capsule 1 is closed.

FIG. 2a shows the same as FIG. 1b. The first chamber 5 of the first part of the cylindrical housing 3 is spaced apart from the second chamber 6 of the second part of the cylindrical housing 4. The first part of the cylindrical housing 3 is now rotated against the second part of the cylindrical housing 4 about the longitudinal axis of the cylindric housing 2, in particular by 90 degrees or 180 degrees or 270 degrees, so that a first outlet opening 7 of the at least one first chamber 5 stands congruently above a second outlet opening 8 of the at least one second chamber 6. When the first outlet opening 7 and the second outlet opening 8 being in congruent position, the at least one first chamber 5 of the first part of the cylindrical housing 3 and the at least one second chamber 6 of the second part of the cylindrical housing 4 communicate with each other. By moving the mixing capsule 1 back and forth, composition A of the first chamber 5 may be transferred into the second chamber 6 and/or composition B of the second chamber 6 may be transferred into the first chamber 5. This situation is illustrated in FIG. 2b. First outlet opening 7 and second outlet opening 8 are situated congruently above each other and composition B of the second chamber 6 has been conveyed into the first chamber 5. By moving the mixing capsule back and forth, composition A and composition B are mixed to composition C. In order to remove composition C from the mixing capsule 1, separation of the first part of the cylindrical housing 3 from the second part of the cylindrical housing 4 is required. By rotating the first part of the cylindrical housing 3 against the second part of the cylindrical housing 4, so that at least one of the three first neodymium magnets 9 of the first part of the cylindrical housing 3 is arranged non-congruently above at least one second neodymium magnet 10 of the second part of the cylindrical housing 4, separation of the first part of the cylindrical housing 3 from the second part of the cylindrical housing 4 may be facilitated.

FIG. 3a shows the first part of the cylindrical housing 3 after separation from the second part of the cylindrical housing 4. The first part of the cylindrical housing 3 stands on the first cylinder 11. Composition C is situated in the first chamber 5. Three first neodymium magnets 9 are arranged on the interface. The first chamber 5 and the three first neodymium magnets 9 are arranged on an imaginary circle, the angular distance between the three first neodymium magnets 9 and the first chamber 5 amounting to 90 degrees respectively.

FIG. 3b shows the second part of the cylindrical housing 4 after separation from the first part of the cylindrical housing 3. The second part of the cylindrical housing 3 stands on the second cylinder 12. Composition B is no longer situated in the second chamber 6. A second neodymium magnet 10 is arranged on the interface. The second chamber 6 and the second neodymium magnet 10 are arranged on an imaginary circle, the angular distance between the second neodymium magnet 10 and the second chamber 6 amounting to 180 degrees respectively.

Alternatively, the housing has the form of a sphere, of an ellipsoid, of a body having a polygonal cross-section, of a rotationally symmetric freeform or of a prism. In case of a sphere, the first part of the housing for example is a first hemisphere and the second part of the housing is a second hemisphere or the first part of the housing is a first partial sphere and the second part of the housing is a second partial sphere. In case of an ellipsoid, the first part of the housing is a first part of the ellipsoid and the second part of the housing is a second part of the ellipsoid. In case of a body having a polygonal cross-section, the first part of the housing is a first part of the body having the polygonal cross-section and the second part of the housing is a second part of the housing having the polygonal cross-section. In case of a rotationally symmetric freeform, the first part of the housing is a first part of the rotationally symmetric freeform and the second part of the housing is a second part of the rotationally symmetric freeform. In case of a prism, the first part of the housing is a first part of the prism and the second part of the housing is a second part of the prism. Conceivable are also hybrid forms to form the housing.

Like this, in a further embodiment, the first part of the housing may be a prism and the second part of the housing may be a hemisphere for example.

### LIST OF REFERENCE NUMERALS

1 mixing capsule

2 housing

3 first part of the housing

4 second part of the housing

5 first chamber

6 second chamber

7 first outlet opening

8 second outlet opening

9 first magnet

10 second magnet

11 first cylinder

12 second cylinder

13 initial opening protection

1. A mixing capsule (1) comprising a housing (2), a first part of the housing (3) being mounted rotatably about a rotational axis against a second part of the housing (4), the rotational axis corresponding to the longitudinal axis of the housing (2), the first part of the housing (3) comprising at least one first chamber (5) to receive a composition A, the second part of the housing (4) comprising at least one second chamber (6) to receive a composition B, the at least one first chamber (5) and the at least one second chamber (6) being initially closed respectively, a first outlet opening (7) of the at least one first chamber (5) standing substantially congruently above a second outlet opening (8) of the at least one second chamber (6) when the first part of the housing (3) being rotated about a predefined angle against the second part of the housing (4), the first outlet opening (7) and/or the second outlet opening (8) being adapted to allow transfer of composition A into the at least one second chamber (6) and/or of composition B into the at least one first chamber (5), the at least one first chamber (5) and the at least one second chamber (6) forming a common mixing chamber when the first outlet opening (7) with the second outlet opening (8) being in substantially congruent position, composition A and composition B being stored mixably to composition C in the common mixing chamber and being mixed to composition C by moving the mixing capsule, the first outlet opening (7) and the second outlet opening (8) not standing congruently to each other in a storing and transport phase,
wherein
the first part of the housing (3) comprises at least one first magnet (9) and the second part of the housing (4) comprises at least one second magnet (10), the at least one first magnet (9) and the at least one second magnet (10) being adapted, when being in congruent position to each other, to keep together the first part of the housing (3) and the second part of the housing (4) to be the housing (2) when the first outlet opening (7) and the second outlet opening (8) being in congruent position and/or in non-congruent position.

2. A mixing capsule according to claim 1, wherein the at least one first magnet (9) and the at least one second magnet (10) comprise neodymium as material.

3. A mixing capsule according to claim 1, wherein, after separation of the first part of the housing (3) from the second part of the housing (4), the at least one first chamber (5) and/or the at least one second chamber (6) are adapted to receive composition C.

4. A mixing capsule according to claim 1, wherein the least one first chamber (5) and/or the at least one second chamber (6) comprise a limited lumen.

5. The mixing capsule according to claim 1, wherein the predefined angle of the rotation of the first part of the housing (3) against the second part of the housing (4), in order to make the first outlet opening (7) of the at least one first chamber (5) standing congruently above a second outlet opening (8) of the at least one second chamber (6), is an angle between 0 and 360 degrees.

6. The mixing capsule according to claim 5, wherein the at least one first chamber (5) and the at least one second chamber (6) communicate with each other when the first outlet opening (7) and the second outlet opening (8) being in a congruent position.

7. The mixing capsule according to claim 1, wherein the first part of the housing (3) has a first cylinder (11) at its side averting the second part and the second part of the housing (4) has a second cylinder (12) at its side averting the first part.

8. The mixing capsule according to claim 1, wherein the first part of the housing (3) and/or the second part of the housing (4) is made of an opaque material.

9. The mixing capsule according to claim 1, wherein the housing of the mixing capsule comprises cyclic olefin polymer, cyclic olefin copolymer(s), polyethylene, polypropylene, polyethylene having low density, polyethylene having high density, polypropylene having low density, polypropylene having high density and/or mixtures containing at least one of said polymers.

10. The mixing capsule according to claim 1, wherein the mixing capsule (1) has an initial opening protection (13), the initial opening protection (13) being adapted to fix the first part of the housing (3) in a rotation-free manner against the second part of the housing (4).

11. A method for mixing at least two compositions A and B to a composition C in a mixing capsule (1) according to claim 1, wherein the method comprises the steps of:
(i) rotating the first part of the housing (3) against the second part of the housing (4), until the first outlet opening (7) of the at least one first chamber (5) stands congruently above the second outlet opening (8) of the at least one second chamber (6);
(ii) mixing composition A and composition B in the common mixing chamber by the mixing capsule being moved;
(iii) separating the first part of the housing (3) from the second part of the housing (4);
(iv) obtaining composition C in the first chamber (5) and/or in the second chamber (6).

12. The method according to claim 11, wherein (iii) mixing composition A and composition B in the common mixing chamber is realised by a universal mixer for dental materials.

13. A method of using a mixing capsule (1) according to claim 1 for storing, mixing and applicating pasty to kneadable compositions.

14. A kit comprising a mixing capsule according to claim 1, comprising a composition A and a composition B.
